(19) United States
(12) Patent Application Publication
(10) Pub. No.: US 2026/0031080 A1
(43) Pub. Date: Jan. 29, 2026

(54) SPEECH SYNTHESIS METHOD AND DEVICE BASED ON CAUCHY DENOISING PROBABILISTIC DIFFUSION MODELS

(71) Applicant: ZHEJIANG UNIVERSITY, Hangzhou (CN)

(72) Inventors: YU QI, HANGZHOU (CN); QI LIAN, HANGZHOU (CN); YUEMING WANG, HANGZHOU (CN)

(21) Appl. No.: 19/281,491

(22) Filed: Jul. 25, 2025

(30) Foreign Application Priority Data
Jul. 26, 2024 (CN) 2024110131756

(51) Int. Cl. G10L 13/02; G06N 3/045; G06N 3/08

(52) U.S. Cl. CPC G10L 13/02; G06N 3/045; G06N 3/08

(57) ABSTRACT

The present invention discloses a speech synthesis method and device based on Cauchy denoising probabilistic diffusion models, comprising: (1) calculating a Cauchy noise table for speech synthesis; (2) calculating a Cauchy posterior square scale table for speech synthesis; (3) implementing a Cauchy diffusion process for speech synthesis; (4) calculating the loss function of Cauchy denoising neural network for speech synthesis; (5) implementing the sampling process of Cauchy denoising diffusion models for speech synthesis. The present invention introduces Cauchy noise into the denoising probabilistic diffusion models, achieves model training and sampling, and ultimately completes speech synthesis. The present invention can improve the robustness of the speech synthesis method and significantly enhance the quality of synthesized speech.

### FIELD OF TECHNOLOGY

The present invention relates to the field of speech synthesis technology, particularly to a speech synthesis method and device based on Cauchy denoising probabilistic diffusion models.

### BACKGROUND TECHNOLOGY

Deep generative models have become the mainstream research direction in recent years and have achieved excellent performance in many fields, comprising computer vision and natural language processing. In the field of deep generative models, there is a type of model called deep iterative generative model, and the most representative deep iterative generative model is the denoising probabilistic diffusion models (DDPM). Specifically, the denoising probabilistic diffusion models is a parametric Markov chain that gradually generates samples that approach reality through hundreds or thousands of noise sampling. The diffusion process of this model gradually adds Gaussian noise to the original signal until the signal becomes standard Gaussian noise. The inverse process of the diffusion process is the sampling process, which continuously adds predicted Gaussian noise and performs denoising until the original signal is reconstructed.

The denoising probabilistic diffusion models can be applied to numerous scenarios, comprising video generation, data generation, image processing, and speech synthesis.

For example, the Chinese patent document with the publication number CN117975980A discloses a speech enhancement acceleration method based on a denoising diffusion probability model. According to a shallow diffusion strategy, the time step of adding Gaussian noise is selected, and then Gaussian noise is added to the speech to be enhanced; a first noise predictor is used to preliminarily denoise the speech to be enhanced with Gaussian noise, and a preliminary denoised speech is obtained. According to a given time step, Gaussian noise is added to the preliminary denoised speech, and a second noise predictor is used to further denoise the preliminary denoised speech with added Gaussian noise, resulting in an enhanced speech.

The Chinese patent document with the publication number CN117744613A discloses a method for generating distribution imbalance table data based on privacy protection, which comprises: inputting a standard Gaussian distribution at a preset time into a reverse denoising module of a denoising probabilistic diffusion models, and outputting a denoised encoded table data, wherein, the denoising probabilistic diffusion models comprises a reverse denoising module and a forward diffusion module, the denoising probabilistic diffusion models is based on adding Gaussian noise to the sample encoding table data in the initial forward diffusion module, predicting Gaussian noise in the initial reverse denoising module, and removing the predicted Gaussian noise obtained through training in advance, the denoising probabilistic diffusion models updates parameters based on differential privacy gradient descent during training; and decoding the denoised encoded table data to obtain synthesized table data.

Contemporary researchers have proposed a large number of denoising probabilistic diffusion models, but these models are mainly based on the sampling and removal of Gaussian noise. The existing technology uses Gaussian noise when using denoising probabilistic diffusion models for speech synthesis. Compared to Gaussian noise, Cauchy noise is more robust, and denoising probabilistic diffusion models based on Cauchy noise are expected to improve the performance of such types of models. It is worth noting that Cauchy noise cannot be directly applied to denoising probabilistic diffusion models because it cannot satisfy one of the core assumptions of denoising probabilistic diffusion models, namely the Kolmogorov equation, which ensures that all conditional distributions during the diffusion and sampling processes are Gaussian distributions.

### SUMMARY OF THE INVENTION

The present invention provides a speech synthesis method and device based on Cauchy denoising probabilistic diffusion models, which can improve the robustness of the speech synthesis method and significantly enhance the quality of synthesized speech.

A speech synthesis method based on Cauchy denoising probabilistic diffusion models, comprising the following steps:
(1) defining two Gaussian denoising probabilistic diffusion models for speech synthesis, comprising a noise table, a single step diffusion operation, and a multi-step diffusion operation for each Gaussian probabilistic diffusion models;
calculating the Cauchy noise table for speech synthesis using the ratio distribution based on the noise tables of two Gaussian denoising probabilistic diffusion models;
(2) calculating a posterior square scale table for each Gaussian denoising probabilistic diffusion models based on the noise table, the single step diffusion operation, and the multi-step diffusion operation;
based on the posterior square scale tables of two Gaussian denoising probabilistic diffusion models, calculating a Cauchy posterior square scale table for speech synthesis by using a ratio distribution;
(3) according to the obtained Cauchy noise table, defining a Cauchy single step diffusion operation; defining the Cauchy multi-step diffusion operation based on the Cauchy noise table and the Cauchy single step diffusion operation;
defining a Cauchy denoising probabilistic diffusion models, which comprises a Cauchy forward diffusion process and a Cauchy inverse sampling process, the Cauchy forward diffusion process comprises the Cauchy single step diffusion operation and the Cauchy multi-step diffusion operation to achieve the training of a denoising neural network; the Cauchy inverse sampling process comprises several single step Cauchy inverse sampling processes to achieve speech synthesis;
(4) building the denoising neural network; constructing a Cauchy noise prediction loss function and a Cauchy posterior squared scale prediction loss function, further constructing a loss function of the denoising neural network, and training the denoising neural network; a specific training process is as follows:
based on the defined Cauchy denoising probabilistic diffusion models and the posterior square scale table, obtaining a true Cauchy noise and a true Cauchy posterior square scale for all diffusion steps, then the denoising neural network calculates a predicted Cauchy noise and a predicted posterior square scale, and trains the denoising neural network based on the loss function;
(5) using Mel spectrogram as a conditional input, speech synthesis is achieved by using the trained denoising neural network; specifically:
for all diffusion steps, the denoising neural network predicts the Cauchy noise and the posterior square scale, and performs a single step Cauchy inverse sampling process on the input noise signal; continuous application of the single step Cauchy inverse sampling process to achieve speech synthesis; the single step Cauchy inverse sampling process comprises a random sampling process and a deterministic sampling process.

The present invention introduces Cauchy noise into the denoising probabilistic diffusion models, achieves model training and sampling, and ultimately completes speech synthesis. The training process of the Cauchy denoising probabilistic diffusion models for speech synthesis aims to train the denoising neural network, comprising calculating the Cauchy noise table, calculating the posterior square scale table of the Cauchy denoising probabilistic diffusion models, implementing the Cauchy diffusion process, and calculating the loss function of the Cauchy denoising neural network. The sampling process of the Cauchy denoising probabilistic diffusion models for speech synthesis aims to use the denoising neural network to predict noise and posterior square scale values, and achieve speech synthesis by continuously applying the single step Cauchy inverse sampling process.

Further, in step (1), a definition of the Cauchy noise table is as follows:

$${β}_{t} = {( \sqrt{( {β}_{t}^{1} )} / \sqrt{( {β}_{t}^{2} )} )}^{2}$$

among them, t represents the current diffusion step; β¹ and β2 represent the noise tables of two Gaussian denoising probabilistic diffusion models respectively;

$${β}_{t}^{1} and {β}_{t}^{2}$$

represent the noise values of two Gaussian denoising probabilistic diffusion models at diffusion step t; β represents the noise table of the Cauchy denoising probabilistic diffusion models; βₜ represents the noise value of the Cauchy denoising probabilistic diffusion models at diffusion step t.

In step (2), a definition of the Cauchy posterior square scale table is as follows:

$${\tilde{β}}_{t} = {( \sqrt{( {\tilde{β}}_{t}^{1} )} / \sqrt{( {\tilde{β}}_{t}^{2} )} )}^{2}$$

$${\tilde{β}}_{t}^{1} = ( 1 - {\overline{α}}_{t - 1}^{1} ) / ( 1 - {\overline{α}}_{t}^{1} ) {β}_{t}^{1}$$

$${\tilde{β}}_{t}^{2} = ( 1 - {\overline{α}}_{t - 1}^{2} ) / ( 1 - {\overline{α}}_{t}^{2} ) {β}_{t}^{2}$$

$${α}_{t}^{1} = 1 - {β}_{t}^{1}$$

$${α}_{t}^{2} = 1 - {β}_{t}^{2}$$

$${\overline{α}}_{t}^{1} = {\prod }_{s = 1}^{t} {α}_{s}^{1}$$

$${\overline{α}}_{t}^{2} = {\prod }_{s = 1}^{t} {α}_{s}^{2}$$

among them, t represents the current diffusion step; \tilde{β}¹ and \tilde{β}² represent the posterior squared scales of two Gaussian denoising probabilistic diffusion models respectively;

$${\tilde{β}}_{t}^{1} and {\tilde{β}}_{t}^{2}$$

respectively represent the posterior squared scale values of two Gaussian denoising probabilistic diffusion models at diffusion step t; \tilde{β} represents the Cauchy posterior square scale table; \tilde{β}ₜ represents the Cauchy posterior square scale value of the Cauchy denoising probabilistic diffusion models at diffusion step t.

In step (3), a definition of the Cauchy single step diffusion operation and the Cauchy multi-step diffusion operation is as follows:

$${\overline{α}}_{t} = {\prod }_{s = 1}^{t} {α}_{s}$$

$${x}_{t} = \sqrt{1 - {β}_{t}} {x}_{t - 1} + \sqrt{{β}_{t}} ∈$$

$${x}_{t} = \sqrt{{\overline{α}}_{t}} {x}_{0} + \sqrt{1 - {\overline{α}}_{t}}$$

among them, t represents the current diffusion step; βₜ represents the noise value of the Cauchy denoising probabilistic diffusion models at diffusion step t; x₀ represents an input speech signal; xₜ₋₁ and xₜ represent speech signals at diffusion step t−1 and t respectively; xₜ=\sqrt{1−βₜ}xₜ₋₁+\sqrt{βₜ}ε represents the Cauchy single step diffusion operation;

$${x}_{t} = \sqrt{{\overline{α}}_{t}} {x}_{0} + \sqrt{1 - {\overline{α}}_{t}}$$

represents the Cauchy multi-step diffusion operation.

In step (4), the denoising neural network is a deep neural network based on the U-Net framework, comprising a temporal mapping module, a downsampling module, and an upsampling module.

In step (4), the loss function of the denoising neural network is defined as follows:

$${L}_{hybrid} = {L}_{γ = 1} + λ {L}_{div}$$

$${L}_{γ = 1} ( {ϵ}_{θ} ) = {\sum }_{t = 1}^{T} {E}_{{x}_{0} , ϵ , t} [ {‖ {ϵ}_{θ} ( \sqrt{{\overline{α}}_{t}} {x}_{0} + \sqrt{1 - {\overline{α}}_{t}} ϵ , t ) - ϵ ‖}_{2}^{2} ]$$

$${L}_{div} = {\sum }_{t = 1}^{T} {L}_{t}$$

$${L}_{t} = log ( \frac{( {\tilde{β}}_{t} + {β}_{θ} ( \sqrt{{\overline{α}}_{t}} {x}_{0} + \sqrt{1 - {\overline{α}}_{t}} ε ,}{4 {\tilde{β}}_{t} {β}_{θ} ( \sqrt{{\overline{α}}_{t}} {x}_{0} + \sqrt{1 - {\overline{α}}_{t}} ε , t )} )$$

$${β}_{θ} ( \sqrt{{\overline{α}}_{t}} {x}_{0} + \sqrt{1 - {\overline{α}}_{t}} ε , t ) = exp ( sigm ( v ) log ( {β}_{t - 1} ) + ( 1 - sigm ( v ) ) log ( {\tilde{β}}_{t - 1} ) )$$

among them, t represents the current diffusion step; L_{γ=1}(ε_{θ}) representing the Cauchy noise prediction loss function; L_{div} represents the Cauchy posterior squared scale prediction loss function; Lₜ represents the Cauchy posterior squared scale prediction loss at diffusion step

$${ϵ}_{θ} ( \sqrt{{\overline{α}}_{t}} {x}_{0} + \sqrt{1 - {\overline{α}}_{t}} ϵ , t )$$

t; represents the Cauchy noise value predicted by the denoising neural network;

$${β}_{θ} ( \sqrt{{\overline{α}}_{t}} {x}_{0} + \sqrt{1 - {\overline{α}}_{t}} ϵ , t )$$

represents the posterior squared scale value predicted by the denoising neural network.

In step (5), the single step Cauchy inverse sampling process is defined as follows:

$${x}_{t - 1} = \sqrt{{\overline{α}}_{t - 1}} ( \frac{{x}_{t} - \sqrt{1 - {\overline{α}}_{t}} {ϵ}_{θ}}{\sqrt{{\overline{α}}_{t}}} + \sqrt{1 - {\overline{α}}_{t} - {ηβ}_{θ}} {ϵ}_{θ} + \sqrt{η {β}_{θ}} ϵ )$$

among them, ε_{θ} represents the Cauchy noise prediction value of the denoising neural network; β_{θ} representing the Cauchy squared scale prediction value of the denoising neural network; when η=0 and η=1, the Cauchy denoising probabilistic diffusion models uses deterministic sampling and stochastic sampling respectively; using Mel spectrogram as the conditional input, standard Cauchy noise is randomly sampled as input, and continuously applying the single step Cauchy inverse sampling process to achieve speech synthesis.

A speech synthesis device based on Cauchy denoising probabilistic diffusion models, comprising a memory and one or more processors, wherein the memory stores executable codes, and when the one or more processors execute the executable codes, the speech synthesis method are implemented.

Compared with the existing technology, the present invention has the following beneficial effects:
1. the speech synthesis method and device based on Cauchy denoising probabilistic diffusion models proposed by the present invention can effectively improve the quality of synthesized speech;
2. the speech synthesis method and device based on Cauchy denoising probabilistic diffusion models proposed in the present invention can effectively preserve the prosodic information contained in different speech, significantly improving the diversity and robustness of synthesized speech.

### BRIEF DESCRIPTION OF THE DRAWINGS

FIG. 1 is a flowchart of a speech synthesis method based on Cauchy denoising probabilistic diffusion models according to an embodiment of the present invention;

FIG. 2 is a schematic diagram of the formation of Cauchy diffusion process;

FIG. 3 shows the performance of the model under multiple truncated values of Cauchy noise at different training steps.

### DETAILED DESCRIPTION OF THE EMBODIMENTS

The present invention will be further described in detail with reference to the accompanying drawings and embodiments. It should be pointed out that the embodiments described below are intended to facilitate the understanding of the present invention and do not limit it in any way.

The dataset used in this embodiment is the LJSpeech dataset, a widely used English speech corpus worldwide. This dataset contains 13100 audio files recorded by a woman, with a sampling rate of 22050 Hz and saved in 16 bit PCM WAV format. The entire dataset has a duration of approximately 24 hours, with an average audio length of around 6.5 seconds. In this embodiment, 100 audio samples are randomly selected as the test set, and the remaining 13000 audio samples are used as the training set. The evaluation indicators comprise PESQ (Perceptual Evaluation of Speech Quality), STOI (Short-Time Objective Intelligibility), and MCD (Mean Compression Distortion).

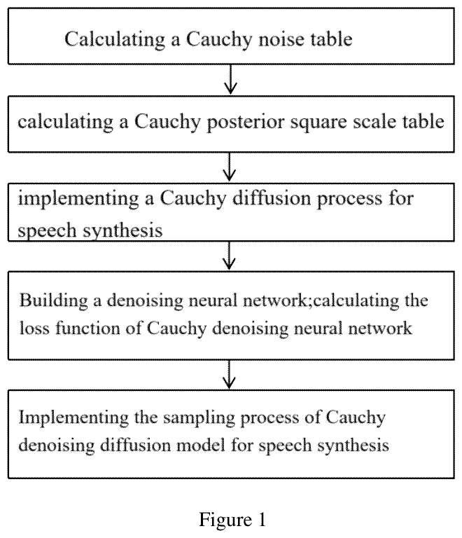

As shown in FIG. 1, a speech synthesis method based on the Cauchy denoising probabilistic diffusion models consists of model training and model sampling, specially comprising the following steps:

S01, calculating a Cauchy noise table for speech synthesis.

Defining two Gaussian denoising probabilistic diffusion models for speech synthesis, comprising a noise table, a single step diffusion operation, and a multi-step diffusion operation for each Gaussian probabilistic diffusion models; calculating the Cauchy noise table for speech synthesis using the ratio distribution based on the noise tables of two Gaussian denoising probabilistic diffusion models.

S02, calculating a Cauchy posterior square scale table for speech synthesis.

Calculating a posterior square scale table for each Gaussian denoising probabilistic diffusion models based on the noise table, the single step diffusion operation, and multi-step diffusion operation; based on the posterior square scale tables of two Gaussian denoising probabilistic diffusion models, calculating a Cauchy posterior square scale table for speech synthesis by using the ratio distribution.

S03, implementing a Cauchy diffusion process for speech synthesis.

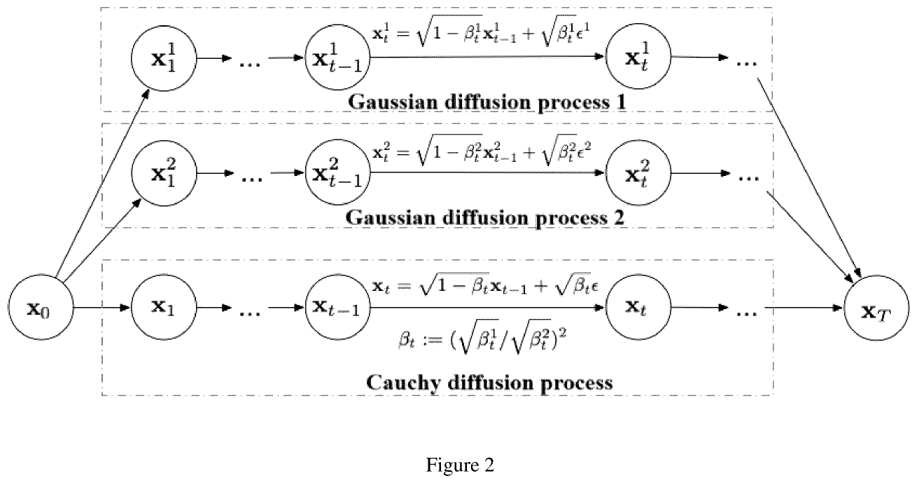

According to the obtained Cauchy noise table, defining a Cauchy single step diffusion operation; defining the Cauchy multi-step diffusion operation based on the Cauchy noise table and the Cauchy single step diffusion operation; the specific implementation of Cauchy diffusion process is shown in FIG. 2.

Defining a Cauchy denoising probabilistic diffusion models, which comprises a Cauchy forward diffusion process and a Cauchy inverse sampling process, the Cauchy forward diffusion process comprises the Cauchy single step diffusion operation and the Cauchy multi-step diffusion operation to achieve the training of denoising neural network; the Cauchy inverse sampling process comprises several single step Cauchy inverse sampling processes to achieve speech synthesis;

S04, calculating the loss function of Cauchy denoising neural network for speech synthesis.

Building a denoising neural network; constructing a Cauchy noise prediction loss function and a Cauchy posterior squared scale prediction loss function, further constructing a loss function of the denoising neural network, and training the denoising neural network.

S05, implementing the sampling process of Cauchy denoising diffusion models for speech synthesis.

Using Mel spectrogram as a conditional input, speech synthesis is achieved by using the trained denoising neural network; for all diffusion steps, the denoising neural network predicts the Cauchy noise and the posterior square scale, and performs a single step Cauchy inverse sampling process on the input noise signal; continuous application of the single step Cauchy inverse sampling process to achieve speech synthesis; the single step Cauchy inverse sampling process comprises random sampling process and deterministic sampling process.

In the embodiment of the present invention, model training specifically comprises the following steps:
(1) audio data preprocessing: using a short-time Fourier transform to extract 80 band Mel spectrograms from audio files as conditional inputs. Among them, the parameters of the short-time Fourier transform are set as follows: Fourier transform length is set to 1024, jump length is set to 256, and window length is set to 1024. The minimum and maximum frequencies of the Mel spectrogram are set to 0 and 8000. The training process prunes 62 frames from the complete Mel spectrogram as input, corresponding to audio slices with a length of 15872 sample points in the original audio file.
(2) establishing a denoising neural network: the denoising neural network used in this embodiment is a U-Net type deep neural network. The denoising neural network consists of a temporal mapping module, a downsampling module, and an upsampling module.
(2-1) the temporal mapping module: the temporal mapping module is a two-layer nonlinear neural network, each layer containing 512 neurons, the nonlinear activation function uses SiLU function, and the input of this module is the position code.
(2-2) the downsampling module: the downsampling module consists of two parts, the first part contains a one-dimensional convolutional layer with a kernel size of 7 and convolutional channels of 32. The second part contains three similar components, with downsampling rates of 4, 8, and 8, respectively. The first layer of each component is a one-dimensional convolution with a kernel size of 3, corresponding to three components, with expansion factors and padding sizes set to 1, 2, and 4, respectively. Before performing convolution, the input of each component is mapped to the necessary dimensions using nearest neighbor interpolation, and there are skip connections between the components. This skip connection consists of a single one-dimensional linear convolution and nearest neighbor interpolation.
(2-3) the upsampling module: the upsampling module consists of LVC convolutional layers. The LVC convolutional layers can learn multiple sets of convolutional kernels based on Mel spectrogram to achieve local speech feature modeling over a long range of audio. The upsampling module consists of three components, with upsampling rates of 8, 8, and 4, respectively. Each upsampling component consists of three LVC convolutional layers, each with 256 neurons. The convolutional channels and kernel sizes of the convolutional kernel predictor in each LVC convolutional layer are set to 64 and 3, respectively. Before performing LVC convolution, each component's input is mapped to the necessary dimensions by using deconvolution. The upsampling module utilizes Leaky ReLU to provide nonlinearity, with a parameter value negative slope set to 0.2.
(3) implementing the Cauchy denoising probabilistic diffusion models:
(3-1) calculating the Cauchy noise table and the posterior square scale table of the Cauchy denoising probabilistic diffusion models.
(3-2) calculating the loss function of the Cauchy denoising neural network for any diffusion step signal based on the Cauchy diffusion process.
(4) training the denoising neural network:

Training the denoising neural network based on the loss function. The training process adopts gradient descent method and updates the weights of the denoising neural network by using AdamW optimizer. The betas parameters of the AdamW optimizer are set to 0.9 and 0.98. The batch size of the sample is set to 64, and the learning rate is set to 0.0002. The training process uses weight regularization techniques and gradient truncation techniques, with the truncation criterion being that the maximum norm of the gradient is 1. In addition, the exponential moving average technique is also used to update the model weights. For every 10 training steps, the exponential moving average will smooth the weights at a ratio of 0.999.

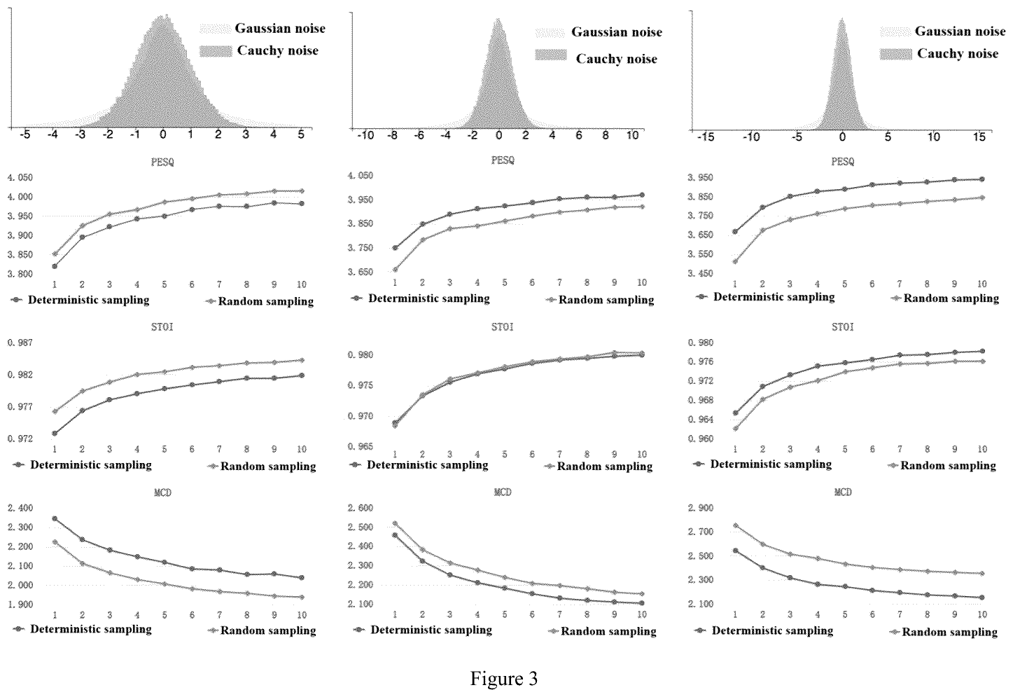

This embodiment compares the speech synthesis method of the present invention with other speech synthesis methods on the LJSpeech dataset, and the results are shown in Table 1. It can be seen that the Cauchy Diffusion denoising probabilistic diffusion models based on Cauchy noise proposed in the present invention achieves better performance than other speech synthesis methods in speech synthesis problems. In addition, during specific implementation, the Cauchy noise truncation value has a significant impact on model training and sampling, as shown in FIG. 3. The horizontal axis represents the number of training steps for the denoising model, measured in one million training steps. From left to right, the noise truncation values are 5, 10, and 15, respectively. It can be seen that when the noise truncation value is larger, the model converges more slowly.

TABLE 1
Performance Comparison of Different Speech Synthesis Algorithms

| Method | PESQ | STOI | MCD |
|---|---|---|---|
| WaveGlow | 3.517 ± 0.149 | 0.953 ± 0.011 | 3.178 ± 0.572 |
| HiFiGAN | 3.679 ± 0.212 | 0.980 ± 0.007 | 2.136 ± 0.504 |
| UnivNet | 3.663 ± 0.193 | 0.978 ± 0.008 | 2.249 ± 0.518 |
| WaveGrad | 3.732 ± 0.155 | 0.972 ± 0.009 | 2.295 ± 0.523 |
| DiffWave | 3.866 ± 0.118 | 0.978 ± 0.008 | 2.062 ± 0.521 |
| Fastdiff | 3.969 ± 0.096 | 0.980 ± 0.006 | 2.899 ± 0.772 |
| Cauchy Diffusion (η = 0) | 3.978 ± 0.100 | 0.982 ± 0.006 | 2.027 ± 0.501 |
| Cauchy Diffusion (η = 1) | 4.014 ± 0.072 | 0.985 ± 0.005 | 1.929 ± 0.480 |

The above embodiments have provided detailed explanations of the technical solutions and beneficial effects of the present invention. It should be understood that the above embodiments are only specific examples of the present invention and are not intended to limit the present invention. Any modifications, supplements, or equivalent substitutions made within the scope of the principles of the present invention should be included in the scope of protection of the present invention.

1. A speech synthesis method based on Cauchy denoising probabilistic diffusion models, comprising the following steps:
(1) defining two Gaussian denoising probabilistic diffusion models for speech synthesis, comprising a noise table, a single step diffusion operation, and a multi-step diffusion operation for each Gaussian probabilistic diffusion models;
calculating the Cauchy noise table for speech synthesis using the ratio distribution based on the noise tables of two Gaussian denoising probabilistic diffusion models;
(2) calculating a posterior square scale table for each Gaussian denoising probabilistic diffusion models based on the noise table, the single step diffusion operation, and the multi-step diffusion operation;
based on the posterior square scale tables of two Gaussian denoising probabilistic diffusion models, calculating a Cauchy posterior square scale table for speech synthesis by using a ratio distribution;
(3) according to the obtained Cauchy noise table, defining a Cauchy single step diffusion operation; defining the Cauchy multi-step diffusion operation based on the Cauchy noise table and the Cauchy single step diffusion operation;
defining Cauchy denoising probabilistic diffusion models, which comprise a Cauchy forward diffusion process and a Cauchy inverse sampling process, the Cauchy forward diffusion process comprises the Cauchy single step diffusion operation and the Cauchy multi-step diffusion operation to achieve the training of a denoising neural network; the Cauchy inverse sampling process comprises several single step Cauchy inverse sampling processes to achieve speech synthesis;
(4) building the denoising neural network; constructing a Cauchy noise prediction loss function and a Cauchy posterior squared scale prediction loss function, further constructing a loss function of the denoising neural network, and training the denoising neural network; a specific training process is as follows:
based on the defined Cauchy denoising probabilistic diffusion models and the posterior square scale table, obtaining a true Cauchy noise and a true Cauchy posterior square scale for all diffusion steps, then the denoising neural network calculating a predicted Cauchy noise and a predicted posterior square scale, and training the denoising neural network based on the loss function;
(5) using Mel spectrogram as a conditional input, achieving speech synthesis by using the trained denoising neural network; specifically:
for all diffusion steps, the trained denoising neural network predicting the Cauchy noise and the posterior square scale, and performing a single step Cauchy inverse sampling process on the input noise signal; continuous applying the single step Cauchy inverse sampling process to achieve speech synthesis; the single step Cauchy inverse sampling process comprising random sampling process and deterministic sampling process.

2. The speech synthesis method based on Cauchy denoising probabilistic diffusion models according to claim 1, wherein, in step (1), a definition of the Cauchy noise table is as follows:
$${β}_{t} = {( \sqrt{( {β}_{t}^{1} )} / \sqrt{( {β}_{t}^{2} )} )}^{2}$$
among them, t represents the current diffusion step; β¹ and β² represent the noise tables of two Gaussian denoising probabilistic diffusion models respectively;
$${β}_{t}^{1} and {β}_{t}^{2}$$
represent the noise values of two Gaussian denoising probabilistic diffusion models at diffusion step t; β represents the noise table of the Cauchy denoising probabilistic diffusion models; βₜ represents the noise value of the Cauchy denoising probabilistic diffusion models at diffusion step t.

3. The speech synthesis method based on Cauchy denoising probabilistic diffusion models according to claim 1, wherein, in step (2), a definition of the Cauchy posterior square scale table is as follows:
$${\tilde{β}}_{t} = {( \sqrt{( {\tilde{β}}_{t}^{1} )} / \sqrt{( {\tilde{β}}_{t}^{2} )} )}^{2}$$
$${\tilde{β}}_{t}^{1} = ( 1 - {\overline{α}}_{t - 1}^{1} ) / ( 1 - {\overline{α}}_{t}^{1} ) {β}_{t}^{1}$$
$${\tilde{β}}_{t}^{2} = ( 1 - {\overline{α}}_{t - 1}^{2} ) / ( 1 - {\overline{α}}_{t}^{2} ) {β}_{t}^{2}$$
$${α}_{t}^{1} = 1 - {β}_{t}^{1}$$
$${α}_{t}^{2} = 1 - {β}_{t}^{2}$$
$${\overline{α}}_{t}^{1} = {{\prod }_{s = 1}}^{t} {α}_{s}^{1}$$
$${\overline{α}}_{t}^{2} = {{\prod }_{s = 1}}^{t} {α}_{s}^{2}$$
among them, t represents the current diffusion step; \tilde{β}₁ and \tilde{β}₂ represent the posterior squared scales of two Gaussian denoising probabilistic diffusion models respectively;
$${\tilde{β}}_{t}^{1} and {\tilde{β}}_{t}^{2}$$
respectively represent the posterior squared scale values of two Gaussian denoising probabilistic diffusion models at diffusion step t; \tilde{β} represents the Cauchy posterior square scale table; \tilde{β}ₜ represents the Cauchy posterior square scale value of the Cauchy denoising probabilistic diffusion models at diffusion step t.

4. The speech synthesis method based on Cauchy denoising probabilistic diffusion models according to claim 1, wherein, in step (3), a definition of the Cauchy single step diffusion operation and the Cauchy multi-step diffusion operation is as follows:
$${\overline{α}}_{t} = {\prod }_{s = 1}^{t} {α}_{s}$$
$${x}_{t} = \sqrt{1 - {β}_{t}} {x}_{t - 1} + \sqrt{{β}_{t}} ϵ$$
$${x}_{t} = \sqrt{{\overline{α}}_{t}} {x}_{0} + \sqrt{1 - {\overline{α}}_{t}}$$
among them, t represents the current diffusion step; βₜ represents the noise value of the Cauchy denoising probabilistic diffusion models at diffusion step t; x₀ represents an input speech signal; xₜ₋₁ and xₜ represent speech signals at diffusion step t−1 and t respectively; xₜ+\sqrt{1−βₜ}xₜ₋₁+\sqrt{βₜ}ε represents the Cauchy single step diffusion operation;
$${x}_{t} = \sqrt{{\overline{α}}_{t}} {x}_{0} + \sqrt{1 - {\overline{α}}_{t}}$$
represents the Cauchy multi-step diffusion operation.

5. The speech synthesis method based on Cauchy denoising probabilistic diffusion models according to claim 1, wherein, in step (4), the denoising neural network is a deep neural network based on the U-Net framework, comprising a temporal mapping module, a downsampling module, and an upsampling module.

6. The speech synthesis method based on Cauchy denoising probabilistic diffusion models according to claim 1, wherein, in step (4), the loss function of the denoising neural network is defined as follows:
$${L}_{hybrid} = {L}_{γ = 1} + λ {L}_{div}$$
$${L}_{γ = 1} ( {ϵ}_{θ} ) = {\sum }_{t = 1}^{T} {E}_{{x}_{0} , ϵ , t} [ {‖ϵ}_{θ} ( \sqrt{{\overline{α}}_{t}} {x}_{0} + \sqrt{1 - {\overline{α}}_{t}} ϵ , t ) - {ϵ‖}_{2}^{2} ]$$
$${L}_{div} = {\sum }_{t = 1}^{T} {L}_{t}$$
$${L}_{t} = log ( \frac{{( {\tilde{β}}_{t} + {β}_{θ} ( \sqrt{{\overline{α}}_{t}} {x}_{0} + \sqrt{1 - {\overline{α}}_{t}} ϵ , t ) )}^{2}}{4 {\tilde{β}}_{t} {β}_{θ} ( \sqrt{{\overline{α}}_{t}} {x}_{0} + \sqrt{1 - {\overline{α}}_{t}} ϵ , t )} )$$
$${β}_{θ} ( \sqrt{{\overline{α}}_{c}} {x}_{0} + \sqrt{1 - {\overline{α}}_{c}} ϵ , t ) = exp ( sigm ( v ) log ( {β}_{t - 1} ) + ( 1 - sigm ( v ) ) log ( {\tilde{β}}_{t - 1} ) )$$
among them, t represents the current diffusion step; L_{γ=1} (ε_{θ}) representing the Cauchy noise prediction loss function; L_{div} represents the Cauchy posterior squared scale prediction loss function; Lₜ represents the Cauchy posterior squared scale prediction loss at diffusion step t;
$${ϵ}_{θ} ( \sqrt{{\overline{α}}_{t}} {x}_{0} + \sqrt{1 - {\overline{α}}_{t}} ϵ , t )$$
represents the Cauchy noise value predicted by the denoising neural network;
$${β}_{θ} ( \sqrt{{\overline{α}}_{t}} {x}_{0} + \sqrt{1 - {\overline{α}}_{t}} ϵ , t )$$
represents the posterior squared scale value predicted by the denoising neural network.

7. The speech synthesis method based on Cauchy denoising probabilistic diffusion models according to claim 1, wherein, in step (5), the single step Cauchy inverse sampling process is defined as follows:
$${x}_{t - 1} = \sqrt{{\overline{α}}_{t - 1}} ( \frac{{x}_{t} - \sqrt{1 - {\overline{α}}_{t}} {ϵ}_{θ}}{\sqrt{{\overline{α}}_{t}}} + \sqrt{1 - {\overline{α}}_{t} - {ηβ}_{θ}} {ϵ}_{θ} + \sqrt{η {β}_{θ}} ϵ )$$
among them, ε_{θ} represents the Cauchy noise prediction value of the denoising neural network; β_{θ} representing the Cauchy squared scale prediction value of the denoising neural network; when η=0 and η=1, the Cauchy denoising probabilistic diffusion models uses deterministic sampling and stochastic sampling respectively; using Mel spectrogram as the conditional input, standard Cauchy noise being randomly sampled as input, and continuously applying the single step Cauchy inverse sampling process to achieve speech synthesis.

8. A speech synthesis device based on Cauchy denoising probabilistic diffusion models, comprising a memory and one or more processors, wherein the memory stores executable code, and when the one or more processors execute the executable code, the speech synthesis method according to claim 1 are implemented.
